(19) United States
(12) Patent Application Publication
(10) Pub. No.: US 2021/0097557 A1
(43) Pub. Date: Apr. 1, 2021

(54) METHOD AND APPARATUS FOR OPTIMIZING OBJECT PREDICTION AND STORAGE MEDIUM

(71) Applicant: FUJITSU LIMITED, Kawasaki-shi (JP)

(72) Inventor: Rujie LIU, Beijing (CN)

(73) Assignee: FUJITSU LIMITED, Kawasaki-shi (JP)

(21) Appl. No.: 16/851,759

(22) Filed: Apr. 17, 2020

(30) Foreign Application Priority Data
Sep. 26, 2019 (CN) 201910918057.2

(51) Int. Cl. G06Q 30/02; G06N 20/00; G06F 17/14

(52) U.S. Cl. CPC G06Q 30/0202; G06F 17/142; G06N 20/00

(57) ABSTRACT

A method and an apparatus for optimizing object prediction and a storage medium are provided according to the present disclosure. The method includes: grouping multiple objects, where each group of objects have similar characteristics; building a predictor library for each group of objects, respectively; determining, in the predictor library of each group of objects, an initial corresponding predictor for each object, based on historical characteristic data with a fixed length of time related to each object; and dynamically updating the initial corresponding predictor for each object, respectively, by using characteristic data varying with time and related to each object, where a prediction performance of the updated corresponding predictor is optimal with respect to the characteristic data varying with time and related to each object.

### CROSS REFERENCE TO RELATED APPLICATION

This application is based on and claims priority under 35 U.S.C. § 119 to Chinese Patent Application No. 201910918057.2 filed on Sep. 26, 2019, in the China National Intellectual Property Administration and entitled “Method and Apparatus for Optimizing Object Prediction and Storage Medium” the disclosure of which is incorporated herein by reference in its entirety.

### TECHNICAL FIELD

The present disclosure relates to the field of demand prediction, and in particular to a method and apparatus for optimizing product demand prediction.

### BACKGROUND

Sales prediction is an important basis for enterprise management decision, and is a precondition of a proper inventory control, a transportation schedule planning, and a whole supply chain's optimization. An accurate sales prediction can instruct a backend operation to perform reasonable resource configuration and optimization beforehand, thereby avoiding a waste of resources and a bottleneck of resource usage. For example, the beforehand reasonable resource configuration and optimization may be beforehand construction of a call center and a logistics center, beforehand reserves of staff in the call center, a beforehand purchase and inventorying of packaging and consumable items. A prediction accuracy of product sales is a main influential factor on enterprise operation efficiency. If the prediction accuracy is high, a quick turnover of capital and inventory can be achieved even if a reaction rate of a reaction chain is not high enough. The sales prediction is foundation of procurement management, replenishment management, sales management and the like.

The sales prediction is of vital guiding significance for enterprise operation, including: instructing the backend operation to reasonably configure and optimize resources beforehand, thereby avoiding the waste of resources and the bottleneck of resource usage;

instructing a factory to plan and operate efficiently (for example, reducing a shortage of raw materials in a case that demand exceeds supply and improving asset utilization ratio and the like); responding sensitively to customers and market such that a manufacture has more chances to sale out more products; planning and controlling finished goods inventory well thereby avoiding out-of-stock and excessive inventory.

The sales prediction is made by taking a specific product as a prediction object, such as a merchandise sold by a dealer and a product produced by a factory. With the development of economy, categories of the product become diversified, and a matrix of the product becomes more complex. Therefore, a demand for the sales prediction becomes increasingly urgent, and a difficulty of the sales prediction is increasing. In addition, an enterprise also need to consider an influence of various festivals and consumption hot spots on sales, and new arrival plans and sales promotions appear on the market one after another, therefore, the above factors improve difficulty of the sales prediction further.

A sales prediction system may be divided into a time series-based sales prediction system and a machine learning-based sales prediction system according to a core process of the sales prediction system.

The time series-based sales prediction system analyzes series data arranged in order of time and establish a mathematic model by means of curve fitting and parameter estimation to predict future trend. A method used in the time series-based sales prediction system is mainly based on principle of statistics and has a high requirement for accumulated data volume. In addition, a prediction effect is poor in a case that the trend of the data is not evident. This method is generally adopted in a conventional sales prediction system.

In the machine learning-based sales prediction system, a model has a capability of self-improving by using an assumption and algorithms. In addition, a requirement for data volume is low. This system is a fashion of the moment and is applied in many big enterprises such as ABInbev and Mengniu Dairy Group. However, machine learning has scenario limitations and the prediction is based on a correlation between factors rather than a causation between factors, such that disadvantages also exist in this system.

### SUMMARY

In the following, an overview of the present disclosure is given simply to provide basic understanding to some aspects of the present disclosure. It should be understood that this overview is not an exhaustive overview of the present disclosure. It is neither intended to determine a critical part or an important part of the present disclosure, nor to limit the scope of the present disclosure. An object of the overview is only to give some concepts in a simplified manner, which serves as a preface of a more detailed description described later.

A method for optimizing object prediction is provided according to an aspect of the present disclosure. The method includes: grouping multiple objects, where each group of objects have similar characteristics; building a predictor library for each group of objects, respectively; determining, in the predictor library of each group of objects, an initial corresponding predictor for each object, based on historical characteristic data with a fixed length of time related to each object; and dynamically updating the initial corresponding predictor for each object, respectively, by using characteristic data varying with time and related to each object, where a prediction performance of the updated corresponding predictor is optimal with respect to the characteristic data varying with time and related to each object.

An apparatus for optimizing object prediction is provided according to another aspect of the present disclosure. The apparatus includes a memory and a processor where the processor is configured to: group multiple objects, where each group of objects have similar characteristics; build a predictor library for each group of objects, respectively; determine, in the predictor library of each group of objects, an initial corresponding predictor for each object, based on historical characteristic data with a fixed length of time related to each object; and dynamically update the initial corresponding predictor for each object, respectively, by using characteristic data varying with time and related to each object, where a prediction performance of the updated corresponding predictor is optimal with respect to the characteristic data varying with time and related to each object.

Corresponding computer program codes, a computer readable storage medium and a computer program product are provided according to other aspects of the present disclosure.

With the object prediction method and apparatus according to the present disclosure, the prediction speed is increased and the prediction accuracy is improved, thereby saving an inventory cost.

Hereinafter, preferred embodiments of the present disclosure are described in detail in conjunction with the drawings, and these and other advantages of the present disclosure become more apparent.

### BRIEF DESCRIPTION OF THE DRAWINGS

To further set forth the above and other advantages and features of the present disclosure, detailed description of the embodiments of the disclosure will be made in the following in conjunction with the drawings in which like reference signs designate components having like function and structure. The drawings, together with the detailed description below, are incorporated into and form a part of the specification. It should be noted that the drawings only illustrate typical embodiments of the present disclosure and should not be construed as a limitation to the scope of the present disclosure. In the drawings:

FIG. 1 schematically shows a prediction method according to the present disclosure;

FIG. 2 is a flowchart of a method for optimizing object prediction according to an embodiment;

FIG. 3 exemplarily shows a sales volume curve of four merchandises in the past two years;

FIG. 4 exemplarily shows a graph of a clustering result;

FIG. 5 is a block diagram of an apparatus for optimizing object prediction according to an embodiment; and

FIG. 6 is a block diagram showing an exemplary structure of a general personal computer that can implement the method and/or the apparatus according to an embodiment of the present disclosure.

### DETAILED DESCRIPTION OF THE EMBODIMENTS

An exemplary embodiment of the present disclosure will be described hereinafter in conjunction with the accompanying drawings. For the purpose of conciseness and clarity, not all features of an embodiment are described in this specification. However, it should be understood that multiple decisions specific to the embodiment have to be made in a process of developing any such embodiment to realize a particular object of a developer, for example, conforming to those constraints related to a system and a business, and these constraints may change as the embodiments differs. Furthermore, it should also be understood that although the development work may be very complicated and time-consuming, for those skilled in the art benefiting from the present disclosure, such development work is only a routine task.

Here, it should also be noted that, in order to avoid obscuring the present disclosure due to unnecessary details, only an apparatus structure and/or processing steps/operations closely related to the solution according to the present disclosure are illustrated in the drawings, and other details having little relationship to the present disclosure are omitted.

It is well-known that inventory management is an important technology, and inventory management directly affects enterprise profit capability and client service level. An effective inventory management requires a good compromise between a stock level and the client service level. A big global market is constituted for the inventory management.

According to a report from an American consulting company IHL GROUP in 2015, global retailers lost about 1.75 trillions of dollars (costs on an excessive inventory, an out-of-stock and an unnecessary return) in inventory management every year, and the lost is up to 11.7% of income. On the other hand, an investigation form the Hackett Group in 2017 shows that inventory products in the 1000 largest American headquarters occupy 4120 billion dollars of working capital.

A major problem existed in current inventory management is due to a lack of accurate demand information. That is, if a future demand for products is unknown, it is uncertain that how many products should be kept in the inventory, thereby resulting in the out-of-stock or the excessive inventory. In the present, the future demand for products is generally determined based on individual experiences. That is, an expert estimates the demand based on historical demand data. However, the number of stock keep units (SKUs) of a warehouse is generally very large such as tens of thousands, such that estimating the future demand artificially for each SKU is not feasible.

The present disclosure overcomes or alleviates the above and other deficiencies by providing a method for predicting a future demand for multiple objects (products).

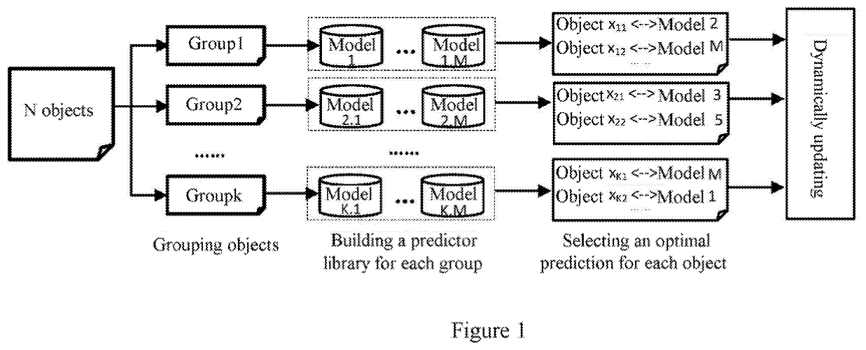

In short, the prediction method according to an embodiment of the present disclosure includes the following stages: 1) grouping N objects into k groups, where each group of objects have similar characteristics; 2) building a predictor library including M predictors for each group of objects, respectively; 3) selecting a predictor with optimal performance as a default predictor for each object; and 4) dynamically updating the optimal predictor for each object. FIG. 1 schematically shows above four stages.

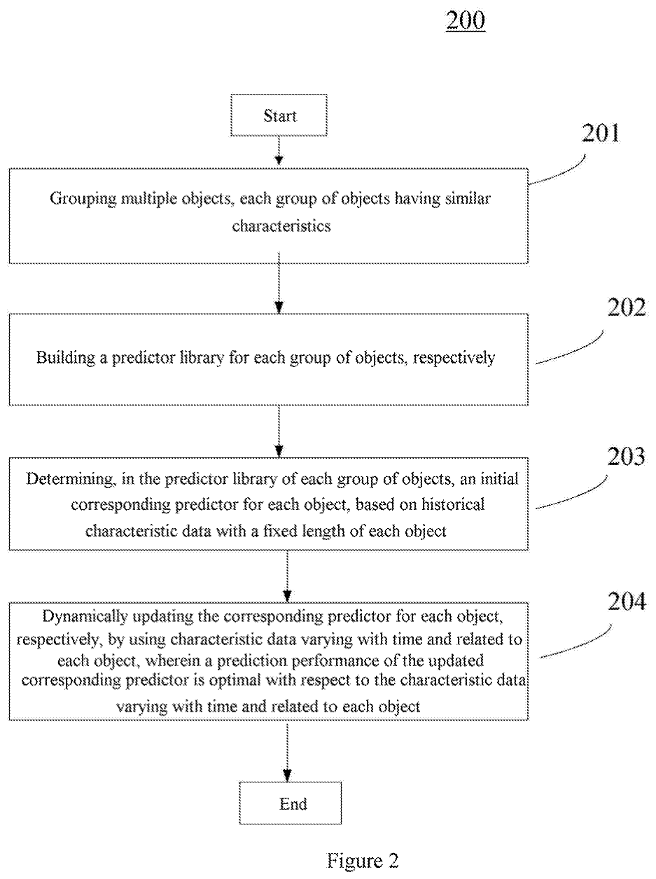

A method 200 for optimizing object prediction according to an embodiment is described in detail below in conjunction with FIG. 2.

The method 200 starts with operation 201. In operation 201, multiple objects are grouped, each group of objects have similar characteristics. In the present embodiment, the objects may be products such as services or goods.

According to an embodiment, the objects may be grouped based on physical attributes depending on different application fields. For example, in a supermarket, cleaning products may be grouped into a group and cooking food products may be grouped into another group. For example, online education products may be grouped into a group and online consulting products may be grouped into another group.

According to another embodiment, objects may be grouped based on historical demand of the objects. It should be understood that the historical demand of the objects refers to historical sales volume characteristics of the objects. For example, sales volumes of merchandises in next week and order quantity of factory products in next season may be grouped based on historical sales volume characteristics of merchandises in the supermarket.

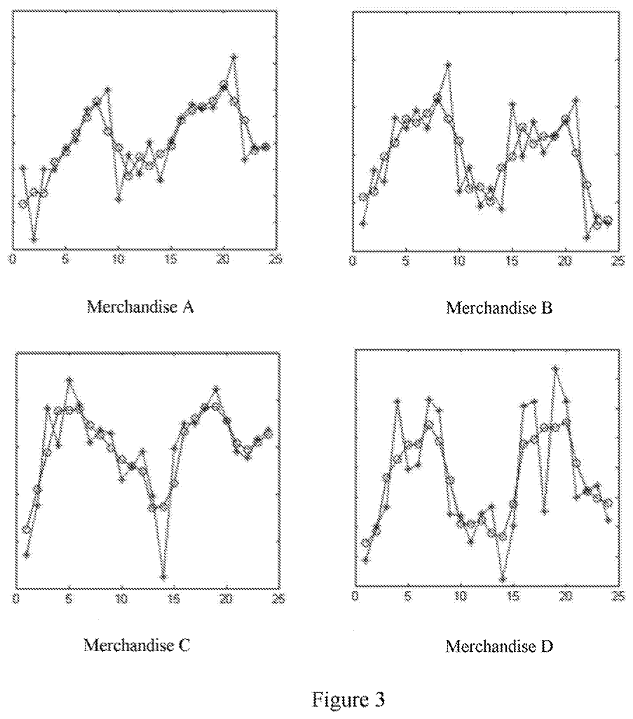

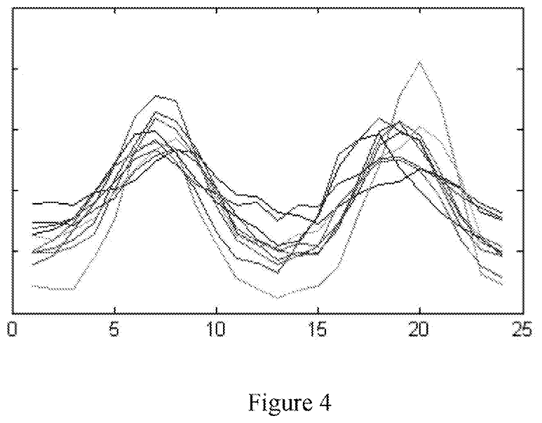

For the supermarket, if an accurate number of the future sales volume of merchandises (the supermarket generally has tens of thousands of merchandises, including daily necessities, foodstuff and the like) is given, a subscription from a supplier can be arranged accurately, thereby reducing fund occupations and inventory costs. A grouping scheme according to the present embodiment is described in detail in conjunction with FIG. 3 and FIG. 4.

It should be noted that in order to obtain the future sales volume of the objects, input information is the historical sales volume of the objects. For example, if a sales volume of a product in the past 12 months is given, output information is a sales volume of the product in next month. The input information and the output information may be summarized as follow. Given a group including N objects X₁, . . . X_{N}, historical sales volume data in the past t time periods is Xᵢ=X_{i,1}, . . . X_{i,t}, where i=1, . . . N correspond to the objects and each Xᵢ is t a dimension vector. The time period may be one day, one week, one month and the like, which depends on different applications. A target is predicting the sales volume in the (t+1)-th time period, and the sales volume in the (t+1)-th time period is represented as X_{i,t+1}.

A clustering strategy may be adopted in order to perform grouping. According to the strategy, a similarity of vectors is measured and N vectors are grouped into K groups.

Some methods may be designed to achieve translation invariance due to seasonal effect and periodic factors. For example, two products having the following historical data are given:
product 1: [30 40 50 60 70 60 50 40]
product 2: [70 60 50 40 30 40 50 60]

The two products have identical characteristics, but there is a translation in time domain between data of the product 1 and data of the product 2. Therefore, the two products may be placed into one group.

Thus, firstly a Fast Fourier Transform (FFT) is performed on raw data. Then amplitudes in the frequency domain are used to calculate the similarity in the clustering.

In the above embodiment, values of the historical data of the product 1 and the product 2 are same. In another embodiment, historical data having similar values are provided:
product 1: [32 40 47 59 73 61 50 42]
product 2: [70 60 50 40 30 40 50 60]

It can be seen that, in this embodiment, values of the historical data of the product 1 has a deviation from that of the product 2. The product 1 and the product 2 may be placed into one group as long as the deviation is within a threshold range. The threshold range may be set based on experiences or requirements.

FIG. 3 schematically shows sales volume curves of four merchandises in the past two years, for understanding the above grouping scheme easily. As shown in FIG. 3, a curve with asterisks represents an initial sales volume, a curve with circles represents a sales volume after a smoothing process is performed on the sales volume. As can be seen from FIG. 3, historical sales volumes of the merchandises have substantially similar characteristics. That is, the sales volume at beginning of a year and the sales volume at end of the year are relatively low, and the sales volume at middle of the year is relative high. FIG. 4 schematically shows a graph of a clustering result where each curve represents historical sales volume data of a merchandise in the past 24 months.

The sales volume data is regarded as a multidimensional vector (for example, historical sales volume data in 12 months is regarded as a 12 dimensional vector) in the above grouping scheme. Then, Fast Fourier Transform of these vectors is calculated and amplitudes of the Fast Fourier Transform are extracted as features. Finally, a clustering is performed based on the features, such that merchandises (goods) having similar sales characteristics are clustered together, that is, the grouping process is performed. The prediction accuracy is improved by placing objects having similar characteristics into one group and performing the same processing on objects in the one group.

It should be understand that the present disclosure is not limited to the two grouping schemes described above. Those skilled in the art can assume any other proper grouping schemes.

Next, in operation 202, a predictor library is built for each group of objects.

Specifically, in the present embodiment, the predictor is trained based on historical demand data of the products for several products in each group of the k groups. The predictor may be based on a linear regression, a regression forest, a random prediction, a support vector regression and the like.

Then, in operation 203, an initial corresponding predictor for each object is determined in the predictor library of each group of objects based on historical characteristic data with a fixed length of each object. Specifically, in the present embodiment, before training the predictor, historical data (demand or sales volume) of products is preprocessed because lengths of historical data of different products may be different. For example, historical data of the product A may start from January 2015 but historical data of the product B may start from March 2016. In most cases, input data with different dimensions cannot be used to build a predictor model.

In an embodiment, raw data of each product may be converted to data with a fixed length by using a sliding window. For example, given that monthly historical data of the product A starts from January 2015 to May 2019, a target length of data for building a predictor model is 12. That is, future demand is predicted based on data in the past one year. By using the sliding window, a first data vector is from January 2015 to December 2015; a second data vector is from February 2015 to January 2016; and so on; a last data vector is from June 2018 to May 2019. After the operation performed with the sliding window, the predictor model may be trained (built) by using all data vectors.

After the predictor is built, each group of products have M predictors. An optimal predictor is found for each product of each group, such that a correspondence between products of each group and the predictors is built. That is, each product has a default optimal predictor. For example, in group k, an optimal predictor corresponding to a product X_{k,1} is a model M. An optimal predictor corresponding to a product X_{k,2} is a model 1.

The default optimal predictor for each product may be determined in the following way. Assuming that a target is to predict, at a current time point t, a volume corresponding to a time point t+1. In that case, a true volume corresponding to the time point t is known. Therefore, a prediction accuracy of all predictors in a process of predicting, at a time point t−1, a volume corresponding to a time point t may be calculated. A predictor with a highest prediction accuracy functions as a default optimal predictor of corresponding product.

It should be understand that the above operation 201 to operation 203 are implemented offline, and operation 201 to operation 203 belong to a pre-training stage.

Finally, in operation 204, the corresponding predictor for each object is dynamically updated respectively by using characteristic data varying with time and related to each object, where a prediction performance of the updated corresponding predictor is optimal with respect to the characteristic data varying with time and related to each object.

Different from operation 201 to operation 203, operation 204 is an online process.

It is known that product demand always varies with time. For example, the product demand varies from uptrend to downtrend. Therefore, an optimal predictor determined for each product at current time is not necessarily an optimal predictor in next time period. Therefore, the default predictor for each product should be updated.

It should be understand that updating of the default predictor may be implemented in a way the same as the above way of determining the initial optimal predictor. That is, a predictor with the highest prediction accuracy at time point t−1 in the predictor library of each group of products is determined to be a new optimal predictor for predicting at time point t+1.

The prediction accuracy is further improved by dynamically updating the optimal predictor for each object.

The methods discussed above may be implemented completely by computer executable programs, or may be partially or completely implemented by hardware and/or firmware. When the methods are implemented by hardware and/or firmware or the computer executable programs are loaded to a hardware apparatus in which programs can be executed, an apparatus for optimizing object prediction to be described is implemented. Hereinafter, the summary of the apparatus is given without repeating some details discussed above. However, it should be noted that, although the apparatus can execute the aforementioned methods, the methods may not include parts of the described apparatus or are not always executed by the parts of the described apparatus.

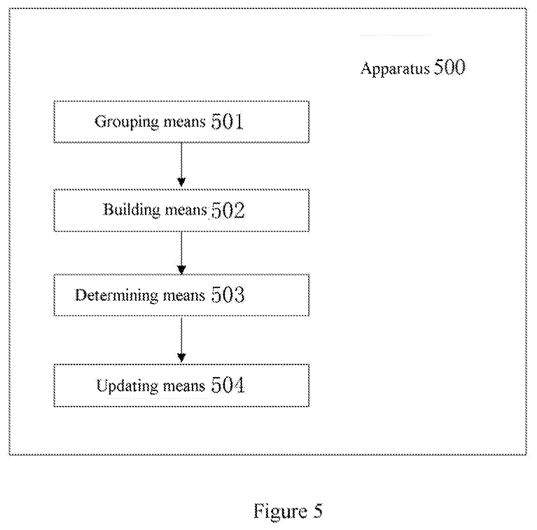

FIG. 5 shows an apparatus 500 for optimizing object prediction according to an embodiment, and the apparatus 500 includes a grouping means 501, a building means 502, a determining means 503 and an updating means 504. The grouping means 501 is configured to group multiple objects, where each group of objects have similar characteristics. The building means 502 is configured to build a predictor library for each group of objects, respectively. The determining means 503 is configured to determine, in the predictor library of each group of objects, an initial corresponding predictor for each object, based on historical characteristic data with a fixed length of each object. The updating means 504 is configured to dynamically update the corresponding predictor for each object, respectively, by using characteristic data varying with time and related to each object, where a prediction performance of the updated corresponding predictor is optimal with respect to the characteristic data varying with time and related to each object.

The apparatus 500 for optimizing object prediction shown in FIG. 5 corresponds to the method 200 shown in FIG. 2. Therefore, related details of each means of the apparatus 500 for optimizing object prediction are given in detail in descriptions for the method 200 for optimizing object prediction shown in FIG. 2, and the related details of the device is not repeated herein.

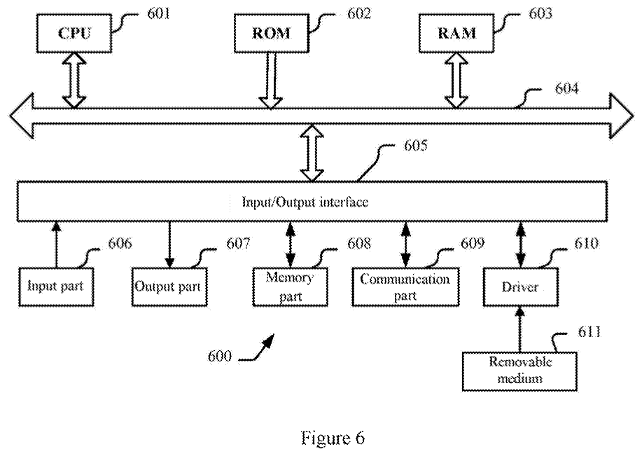

The modules and units of the above apparatuses may be configured with software, firmware, hardware or a combination thereof. The configuration may be made with means or modes well known to those skilled in the art, and is not described hereinafter. In the case where the modules and units are realized by software or firmware, a program constituting the software is installed in a computer with a dedicated hardware structure (e.g. computer 600 shown in FIG. 6) from a storage medium or network, and the computer is capable of implementing various functions when being installed with various programs.

FIG. 6 is a block diagram showing an exemplary structure of a general personal computer that can implement the method and/or the apparatus according to an embodiment of the present disclosure. As shown in FIG. 6, a central processing unit (CPU) 601 executes various processing according to a program stored in a read-only memory (ROM) 602 or a program loaded to a random access memory (RAM) 603 from a memory part 608. The data needed for the various processing of the CPU 601 may be stored in the RAM 603 as needed. The CPU 601, the ROM 602 and the RAM 603 are linked with each other via a bus 604. An input/output interface 605 is also linked to the bus 604.

The following components are linked to the input/output interface 605: an input part 606 (including keyboard, mouse and the like), an output part 607 (including displays such as a cathode ray tube (CRT), a liquid crystal display (LCD), a loudspeaker and the like), a memory part 608 (including hard disc and the like), and a communication part 609 (including a network interface card such as a LAN card, a modem and the like). The communication part 609 performs communication processing via a network such as the Internet. A driver 610 may also be linked to the input/output interface 605, if needed. If needed, a removable medium 611 such as a magnetic disc, an optical disc, a magnetic optical disc and a semiconductor memory may be installed in the driver 610, so that the computer program read therefrom is installed in the memory part 608 as needed.

In the case where the foregoing series of processing is achieved with software, programs forming the software are installed from a network such as the Internet or a memory medium such as the removable medium 611.

It should be appreciated by those skilled in the art that the memory medium is not limited to the removable medium 611 shown in FIG. 6, which has program stored therein and is distributed separately from the apparatus so as to provide the programs to users. The removable medium 611 may be, for example, a magnetic disc (including floppy disc (registered trademark)), a compact disc (including compact disc read-only memory (CD-ROM) and digital versatile disc (DVD), a magneto optical disc (including mini disc (MD)(registered trademark)), and a semiconductor memory. Alternatively, the memory medium may be the hard discs included in ROM 602 and the memory part 608 in which programs are stored, and can be distributed to users along with the apparatus in which they are incorporated.

In addition, computer program codes and a computer program product storing machine-readable instruction codes are further provided according to the present disclosure. The method according to the above embodiments of the present disclosure can be performed when the instruction codes are read and executed by a machine.

Accordingly, a storage medium for carrying the program product in which machine-readable instruction codes are stored is also included in the present disclosure. The storage medium includes but is not limited to floppy, optical disc, magnetic optical disc, memory card, memory stick and the like.

According to an aspect of the present invention, there is provided a method for optimizing object prediction, including: grouping multiple objects, where each group of objects have similar characteristics; building a predictor library for each group of objects, respectively; determining, in the predictor library of each group of objects, an initial corresponding predictor for each object, based on historical characteristic data with a fixed length of each object; and dynamically updating the corresponding predictor for each object, respectively, by using characteristic data varying with time and related to each object, where a prediction performance of the updated corresponding predictor is optimal with respect to the characteristic data varying with time and related to each object. The determining the initial corresponding predictor includes training, by using the historical characteristic data of each object of each group, the predictor library related to the group of objects, to obtain the initial corresponding predictor for each object. The building the predictor library includes selecting, based on similar characteristics of each group of objects, one or more appropriate predictors. The objects are goods or services, and the similar characteristics mean that historical demand volume curves of the goods or services exhibit similar shapes in time domain. The historical demand volume curves are obtained by performing a Fast Fourier Transform on historical demand volume data of the goods or services. The objects are goods or services, and the similar characteristics mean that the goods or services belong to the same application category. The initial corresponding predictor is an optimal predictor for a related object in the predictor library. The objects are goods or services, and the characteristic data varying with time is demand volume data of the goods or services. The dynamically updating the corresponding predictor for each object, respectively, by using the characteristic data varying with time and related to each object includes: using a predictor in the predictor library whose prediction result for each object for a current time period best matches with characteristic data of the object for the current time period, as the corresponding predictor of the object for a next time period. The multiple objects are grouped based on a clustering strategy.

According to another aspect of the present invention, there is provided an apparatus for optimizing object prediction, including: a grouping means configured to group multiple objects, where each group of objects have similar characteristics; a building means configured to build a predictor library for each group of objects, respectively; a determining means configured to determine, in the predictor library of each group of objects, an initial corresponding predictor for each object, based on historical characteristic data with a fixed length of each object; and an updating means configured to dynamically update the corresponding predictor for each object, respectively, by using characteristic data varying with time and related to each object, where a prediction performance of the updated corresponding predictor is optimal with respect to the characteristic data varying with time and related to each object. The determining means is further configured to train, by using the historical characteristic data of each object of each group, the predictor library related to the group of objects, to obtain the initial corresponding predictor for each object. The building means is configured to select, based on similar characteristics of each group of objects, one or more appropriate predictors. The objects are goods or services, and the similar characteristics mean that historical demand volume curves of the goods or services exhibit similar shapes in time domain. The historical demand volume curves are obtained by performing a Fast Fourier Transform on historical demand volume data of the goods or services. The objects are goods or services, and the similar characteristics mean that the goods or services belong to the same application category. The initial corresponding predictor is an optimal predictor for a related object in the predictor library. The objects are goods or services, and the characteristic data varying with time is demand volume data of the goods or services. The updating means is further configured to use a predictor in the predictor library whose prediction result for each object for a current time period best matches with characteristic data of the object for the current time period, as the corresponding predictor of the object for a next time period.

According to yet another aspect of the present invention, there is provided a computer-readable storage medium having stored thereon a program that can be executed by a processor to perform the operations of: grouping multiple objects, where each group of objects have similar characteristics; building a predictor library for each group of objects, respectively; determining, in the predictor library of each group of objects, an initial corresponding predictor for each object, based on historical characteristic data with a fixed length of each object; and dynamically updating the corresponding predictor for each object, respectively, by using characteristic data varying with time and related to each object, where a prediction performance of the updated corresponding predictor is optimal with respect to the characteristic data varying with time and related to each object.

Finally, to be further noted, the term “include”, “comprise” or any variant thereof is intended to encompass nonexclusive inclusion so that a process, method, article or apparatus including a series of elements includes not only those elements but also other elements which have not been listed definitely or an element(s) inherent to the process, method, article or apparatus. Moreover, the expression “comprising a(n) ” in which an element is defined will not preclude presence of an additional identical element(s) in a process, method, article or apparatus comprising the defined element(s) unless further defined.

Although the embodiments of the present disclosure have been described above in detail in connection with the drawings, it shall be appreciated that the embodiments as described above are merely illustrative but not limitative of the present disclosure. Those skilled in the art can make various modifications and variations to the above embodiments without departing from the essence and scope of the present disclosure. Therefore, the scope of the present disclosure is defined merely by the appended claims and their equivalents.

What is claimed is:

1. A method for optimizing object prediction, comprising:
grouping a plurality of objects, wherein each group of objects have similar characteristics;
building a predictor library for each group of objects, respectively;
determining, in the predictor library of each group of objects, an initial corresponding predictor for each object, based on historical characteristic data with a fixed length of time related to each object; and
dynamically updating the initial corresponding predictor for each object, respectively, by using characteristic data varying with time and related to each object, wherein a prediction performance of the updated corresponding predictor is optimal with respect to the characteristic data varying with time and related to each object.

2. The method according to claim 1, wherein the determining of the initial corresponding predictor comprises:
training, by using the historical characteristic data of each object of each group, the predictor library related to a respective group of objects, to obtain the initial corresponding predictor for each object.

3. The method according to claim 1, wherein the building of the predictor library comprises selecting, based on the similar characteristics of each group of objects, one or more appropriate predictors.

4. The method according to claim 1, wherein the plurality of objects represent goods or services, and the similar characteristics of each group of objects mean that historical demand volume curves of the goods or services exhibit similar shapes in time domain.

5. The method according to claim 4, wherein the historical demand volume curves are obtained by performing a Fast Fourier Transform on historical demand volume data of the goods or services.

6. The method according to claim 1, wherein the plurality of objects represent goods or services, and the similar characteristics of each group of objects mean that the goods or services belong to the same application category.

7. The method according to claim 1, wherein the initial corresponding predictor is an optimal predictor for a related object in the predictor library.

8. The method according to claim 1, wherein the plurality of objects are represent goods or services, and the characteristic data varying with time is demand volume data of the goods or services.

9. The method according to claim 1, wherein the dynamically updating of the initial corresponding predictor for each object, respectively, by using the characteristic data varying with time and related to each object comprises:
using a predictor in the predictor library having a prediction result for each object for a current time period that best matches with characteristic data of a respective object for the current time period, as a corresponding predictor of the respective object for a next time period.

10. The method according to claim 1, wherein the grouping of the plurality of objects is based on a clustering strategy.

11. An apparatus for optimizing object prediction, comprising:
a memory; and
a processor coupled to the memory and configured to:
group a plurality of objects, wherein each group of objects have similar characteristics;
build a predictor library for each group of objects, respectively;
determine, in the predictor library of each group of objects, an initial corresponding predictor for each object, based on historical characteristic data with a fixed length of time related to each object; and
dynamically update the initial corresponding predictor for each object, respectively, by using characteristic data varying with time and related to each object, wherein a prediction performance of the updated corresponding predictor is optimal with respect to the characteristic data varying with time and related to each object.

12. The apparatus according to claim 11, wherein the determining by the processor is further configured to train, by using the historical characteristic data of each object of each group, the predictor library related to a respective group of objects, to obtain the initial corresponding predictor for each object.

13. The apparatus according to claim 11, wherein the building by the processor is further configured to select, based on the similar characteristics of each group of objects, one or more appropriate predictors.

14. The apparatus according to claim 11, wherein the plurality of objects are represent goods or services, and the similar characteristics of each group of objects mean that historical demand volume curves of the goods or services exhibit similar shapes in time domain.

15. The apparatus according to claim 14, wherein the historical demand volume curves are obtained by performing a Fast Fourier Transform on historical demand volume data of the goods or services.

16. The apparatus according to claim 11, wherein the plurality of objects are represent goods or services, and the similar characteristics of each group of object mean that the goods or services belong to the same application category.

17. The apparatus according to claim 11, wherein the initial corresponding predictor is an optimal predictor for a related object in the predictor library.

18. The apparatus according to claim 11, wherein the plurality of objects are represent goods or services, and the characteristic data varying with time is demand volume data of the goods or services.

19. The apparatus according to claim 11, wherein the updating by the processor is further configured to use a predictor in the predictor library having a prediction result for each object for a current time period that best matches with characteristic data of a respective object for the current time period, as a corresponding predictor of the respective object for a next time period.

20. A non-transitory computer-readable storage medium having stored thereon a program executable by a processor to perform an operation, comprising:
grouping a plurality of objects, wherein each group of objects have similar characteristics;
building a predictor library for each group of objects, respectively;
determining, in the predictor library of each group of objects, an initial corresponding predictor for each object, based on historical characteristic data with a fixed length of time related to each object; and
dynamically updating the initial corresponding predictor for each object, respectively, by using characteristic data varying with time and related to each object, wherein a prediction performance of the updated corresponding predictor is optimal with respect to the characteristic data varying with time and related to each object.
